(19) United States
(12) Patent Application Publication
(10) Pub. No.: US 2005/0179239 A1
(43) Pub. Date: Aug. 18, 2005

(54) Imaging sensor placement in an airbag deployment system

(76) Inventors: Michael E. Farmer, Bloomfield, MI (US); Mark L. Dell'Eva, Grand Blanc, MI (US); Joseph J. Spryshak, Hartland, MI (US)

Correspondence Address: JAQUEZ & ASSOCIATES, Suite 100D, 6265 Greenwich Drive, San Diego, CA, 92122-5916, US

(21) Appl. No.: 10/778,885

(22) Filed: Feb. 13, 2004

(51) Int. Cl. G05D 1/00

(52) U.S. Cl. 280/735; 701/45

(57) ABSTRACT

An airbag deployment system employing an imaging sensor in order to obtain current information about an occupant is disclosed. The system uses the occupant information to condition the appropriate deployment of the airbag. In particular, the imaging sensor is located according to a combination of one or more constraints, so as to optimize the usefulness of the resulting image information. Location constraints are described in detail with respect to an Airbag Suppression Zone, a windshield header, a vehicle headliner, a radius from a reference Focus Of View point, and a vertical volume containing the seat of the protected occupant. At least one version of all such constraints may be imposed concurrently, or a more limited combination of constraints may be imposed on the camera location.

### BACKGROUND OF THE INVENTION

1. Field of the Invention

This invention generally relates to airbag deployment systems for protecting occupants of vehicles, and more specifically to systems for conditioning airbag deployment based upon imaging information about the occupants.

2. Related Art

Protective airbag systems are commonplace in modern vehicles. As experience with airbags has been gained, it has been concluded that occupant safety may be increased by conditioning airbag deployment on information regarding the occupant to be protected. In particular, it is widely believed that occupants that are rather small may be better served by withholding airbag deployment entirely during an accident, or by reducing the rate or force of such deployment. Even among larger occupants, it may be desirable under some conditions to reduce deployment force, or even to preclude airbag deployment entirely, such as when the occupant is positioned such that ordinary airbag deployment might cause harm, or when the occupant is moving towards the airbag deployment region with significant velocity.

Threshold criteria for airbag deployment are based on conditions that are relevant to the vehicle. Such criteria might be satisfied, for example, when the vehicle is decelerating in a manner that suggests that the safety of an occupant may be in jeopardy. Criteria that are relevant to conditions of the vehicle, as opposed to being relevant to conditions specific to an occupant, may thus be used to reach an initial decision pertaining to airbag deployment. Such exclusively vehicle-relevant criteria might also be used to condition the airbag deployment, for example to limit deployment speed or force below a default or maximum level.

Modern airbag systems may also condition deployment on information that reflects current conditions of an occupant. A variety of techniques have been described in the literature for obtaining information about the protected occupant, upon which such further deployment conditioning may be based. In particular, some techniques “classify” occupants into one of two or more classes, and estimate current occupant position and/or movement. Occupants may be classified, for example, as “small,” “normal,” or “not present,” and airbag deployment may be conditioned upon such classification by reducing the force of deployment, or precluding deployment altogether, for occupants of one class (e.g., “small”) as compared to occupants of another class (e.g., “normal”). As to occupant position and movement, it has been found desirable to condition airbag deployment depending upon such information, so that an occupant that happens to be too close when the airbag deploys is not inadvertently harmed by unnecessarily rapid expansion.

One or more sensors have been used to glean current information about occupants. In particular, imaging sensors may be employed in order to deduce current information about an occupant. Various proposals have been set forth for enabling a vehicle airbag control system and for conditioning airbag deployment upon information derived from an imaging sensor. The following documents are incorporated by reference in their entirety for their teachings in this regard: U.S. Patent Application Ser. No. 09/901,805 by Farmer entitled “Image Processing System for Dynamic Suppression of Airbags Using Multiple Model Likelihoods to Infer Three Dimensional Information” published Feb. 13, 2003; U.S. Patent Application Ser. No. 10/052,152 by Farmer entitled “Image Processing System for Detecting When An Airbag Should Be Deployed” published Feb. 27, 2003; U.S. Pat. No. 6,459,974 issued Oct. 1, 2002 to Baloch, et al., entitled “Rules-Based Occupant Classification System for Airbag Deployment;” and U.S. Pat. No. 6,493,620 issued Dec. 10, 2002 to Zhang, entitled “Motor Vehicle Occupant Detection System Employing Ellipse Shape Models and Bayesian Classification.”

In order for an imaging sensor to derive information about an occupant, the sensor must be positioned where it can discern sufficient features of the occupant. While other sensors may be used to acquire current information about an occupant, an optimally-positioned imaging sensor provides more and better information for use with an airbag deployment system. Indeed, a single optimally-positioned imaging sensor may be capable of providing information sufficient to both classify an occupant, and to determine the current position and/or movement of the occupant. Such a properly positioned imaging sensor may thus remove a need for the expense of one or more additional sensors, or it may provide better information upon which to base airbag deployment decisions. Thus, there is a need for an airbag control system that includes a properly positioned imaging sensor, as well as for a method of controlling airbag deployment based on information from a properly positioned imaging sensor.

### SUMMARY

An airbag deployment control system is set forth that obtains current information about a vehicle occupant from an imaging sensor, and employs such occupant information to condition deployment of an airbag to protect the occupant. For definition, the precise position of the imaging sensor is deemed to be at a received-image point that is representative of the region through which the imaging sensor receives an image of the occupant. The imaging sensor is positioned within the vehicle between concentric spheres that are defined by maximum and minimum radii from a Focus Of View (FOV) point, so that the sensor is with a specified range of distances from the FOV point. The FOV point is located with reference to a standard model of an occupant that is placed in a typical position in the vehicle seat, centered in its fore-aft range of motion, for which the airbag provides protection. The allowable radii of the received-image point from the FOV point may be appropriately limited, as described below in more detail.

Further constraints may be placed upon the imaging sensor position. As one example, the imaging sensor may be positioned such that the received-image point is located within 200 mm of an aft- most vertical plane of an airbag suppression zone, or within 200 mm of the windshield-headliner intersection when that intersection is aft of the airbag suppression zone. Additionally, the imaging sensor may be laterally restricted from any vertical-fore/aft plane that traverses the occupant's seat. The imaging sensor may be limited with respect to a headliner of the vehicle, and may be required to have an unobstructed view of much or all of a top of a window for the occupant. A properly positioned imaging sensor will accord with a combination of one or more of these constraints.

### BRIEF DESCRIPTION OF THE DRAWINGS

Embodiments of the present invention will be more readily understood by reference to the following figures, in which like reference numbers and designations indicate like elements.

FIG. 1 illustrates fore/aft camera placement with respect to an Airbag Suppression Zone (ASZ).

FIG. 2 illustrates fore/aft camera placement with respect to an ASZ as impacted by a windshield/headliner interface.

FIG. 3 illustrates dimensions that are relevant for defining an FOV point location.

FIG. 4 illustrates fore/aft and lateral limitations on camera position.

FIG. 5 illustrates fore/aft and vertical limitations on camera position.

FIG. 6 illustrates lateral and vertical limitations on camera position.

### DETAILED DESCRIPTION

Overview

A vehicle airbag control system utilizing an imaging sensor is described. The imaging sensor, which will be loosely referred to herein as a “camera”, obtains current image information about an occupant of a vehicle. This occupant image information is used to condition airbag deployment in appropriate circumstances. The imaging sensor should be positioned within the vehicle as described below, so as to enhance the occupant information that may be discerned by the sensor. In some cases, positioning as indicated permits a single, solitary camera to provide all current information about the occupant that is required to appropriately condition airbag deployment for the occupant. Information available from a properly positioned imaging sensor may, for example, permit the airbag control system to both classify the occupant in one of a plurality of categories relevant to deployment decisions, and to determine immediate position information for the occupant that is needed to further modify the airbag deployment decisions.

A number of useful constraints on the position of the camera are set forth below. The camera position may be constrained to a region that is defined by a particular spatial relationship to an Airbag Suppression Zone (ASZ). The camera position may be constrained to a region that is defined with respect to a windshield header (i.e., the border between a windshield and a headliner of the vehicle). The camera position may also be constrained to be within a limited range of radii from a Focus Of View (FOV) point that is defined with respect to a typical occupant/seat geometry. Moreover, the camera position may be precluded from location within any vertical-fore/aft plane that touches the occupant, or the occupant's seat. The camera position may be constrained to a region near a headliner of the vehicle, and/or to a position permitting an unobstructed line of sight to much or all of a top of the occupant's window. Additionally, the camera position may be constrained to a region near a headliner of the vehicle, and/or to a position permitting an unobstructed line of sight to the driver's side of the lower passenger seat. An airbag system that conditions airbag deployment on current occupant information as gleaned from an imaging sensor (camera), and which locates the camera according to a combination of one or more of these constraints as described in more detail below, will efficiently and accurately determine how best to condition airbag deployment in order to minimize harm to an occupant.

Unless otherwise noted, location of the imaging sensor (camera) is defined by the location of a representative “received image” point (or image entrance plane center “IEPC” point). The received image point is defined herein as being the center of the surface or planar region through which the image enters the imaging sensor (after which the image is inverted). Thus, if an objective lens is employed, the received image point is the center of the outer surface of the objective lens. If focusing is effected by an opening, the received image point is defined as being the center of the focusing aperture. In the case of a plurality of image-inverting devices, the received image point is defined as being the center of that device upon which incoming light first impinges.

Position information is described in three dimensions, which are referenced to a vehicle in which the airbag control system is disposed. The first dimension is referred to as the fore/aft or “X” dimension. The fore/aft dimension is parallel to lines having a constant lateral position, and a constant vertical position, within the vehicle. FIG. 4 illustrates the fore/aft or “X” dimension with an arrow 50 marked “+X.” Each point of the arrow 50 has the same vertical elevation. The second dimension is referred to as the lateral or “Y” dimension, and is indicated by an arrow 52 marked “+Y” in FIG. 4 (all points of the arrow 52 also have the same vertical elevation). The third dimension is referred to as the vertical or “Z” dimension, which is “out of the paper” with respect to FIG. 4, and is orthogonal to both the X and Y dimensions shown in FIG. 4.

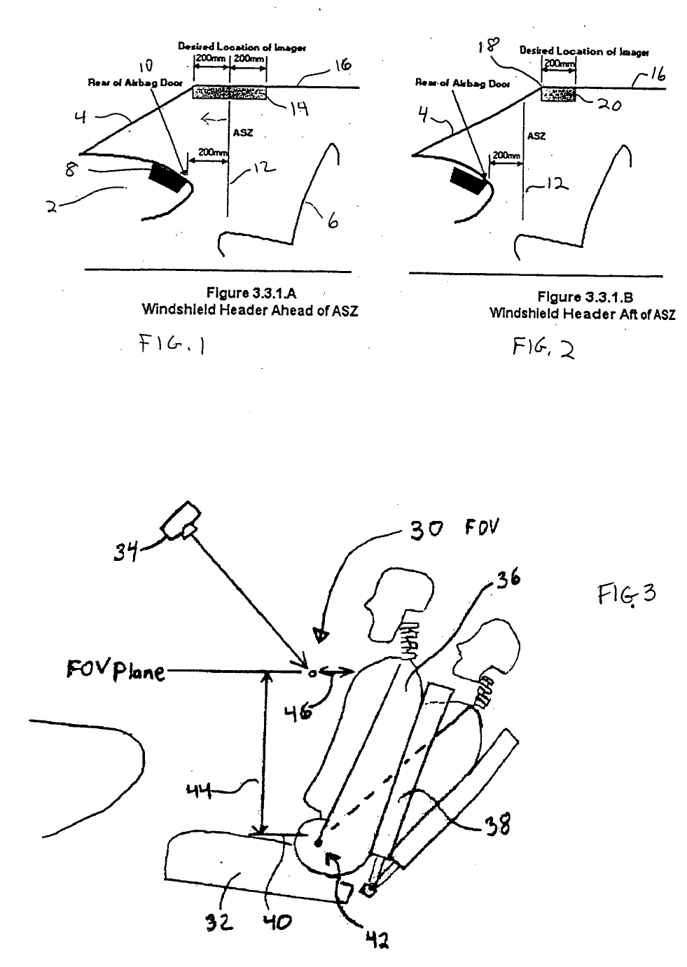

FIG. 1 illustrates a range of desirable camera locations with respect to an airbag suppression zone (ASZ). A dashboard 2 is disposed generally below a windshield 4 and in front of a seat 6, and houses an airbag 8. A door in the dashboard 2, through which the airbag expands upon deployment, includes a rearmost portion 10. Due to the nearly explosive force with which the airbag can be deployed, it is widely considered useful to define an ASZ, within which occupant safety might be jeopardized by full-speed deployment of the airbag. Accordingly, if the airbag is otherwise to be deployed, deployment will be modified or suppressed when it is determined that the occupant is intruding into the ASZ. The exact volume and shape of the ASZ may be determined empirically, and may depend upon a variety of factors, such as, for example, the airbag position in the vehicle, the airbag deployment direction, and the maximum airbag deployment speed. In the exemplary embodiment shown in FIG. 1, the ASZ is indicated by a line 12. The ASZ line 12 represents a Y-Z plane (lateral/vertical plane) that is coincident with the rearmost extent of the ASZ. For the particular embodiment illustrated, the ASZ occupies the entire volume forward of a plane represented by the line 12. The plane represented by the line 12 is the rearmost Y-Z plane of the ASZ, and is 200 mm aft of the rearmost portion 10 of the airbag door.

A camera location region 14 is indicated to be generally close to a headliner 16 of the vehicle. The camera may usefully be restricted to the region 14, which extends 200 mm fore and 200 mm aft of the intersection of the ASZ rearmost Y-Z plane (represented by the line 12) with the headliner 16. In different embodiments, the vertical camera location region may be restricted to be within 50, 75 or 100 mm of the headliner 16.

FIG. 2 is similar to FIG. 1, except that the ASZ rearmost Y-Z plane, represented by the line 12, does not intersect with the headliner 16. This ASZ plane (line 12) does not intersect with the headliner 16 because the windshield header 18 (where the windshield 4 meets the header 16) is aft of the ASZ plane. This may make it physically impractical to restrict the camera location to a position within 200 mm fore or aft of the ASZ plane. As such, an alternative camera location 20 may be restricted to be within 200 mm aft of the windshield header 18, though it may still be limited to a position within 50, 75 or 100 mm of the headliner in various embodiments.

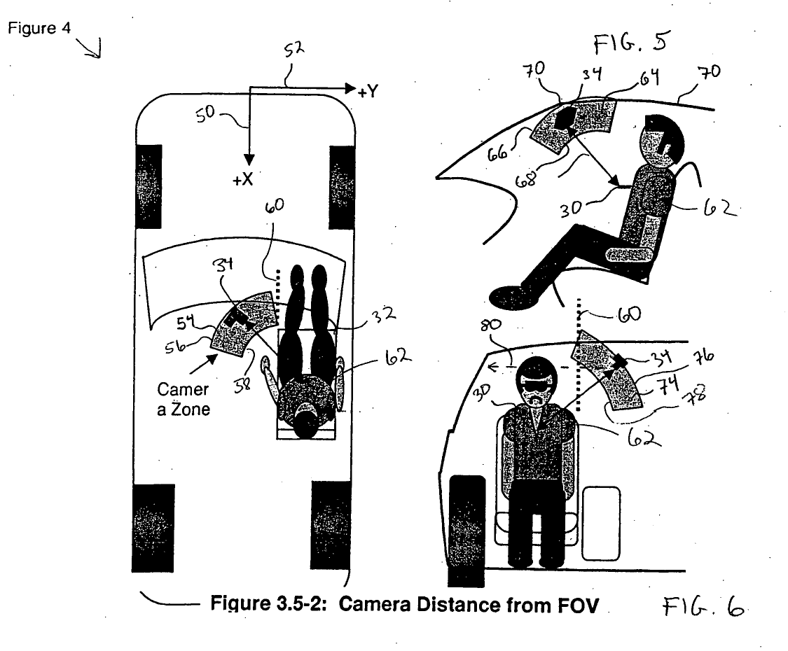

FIG. 3 shows the location of a Focus Of View (FOV) point 30 for an occupant seat 32 in a vehicle. Wherever located, as defined by its received image point, the camera 34 is aligned so that the FOV point is reasonably central within its field of view. That is, the camera 34 may be “aimed” at the FOV point 30. In some embodiments, the camera is positioned such that the FOV point 30 comprises the center of the field of view of the camera.

The FOV point 30 is located a short distance in front of a model 36 representing a nominal occupant of a seat 32 that is centered within its fore/aft range of adjustment. The FOV point 30 is also in a vertical-fore/aft plane that passes through the center of the model. In one embodiment, the model 36 is an anthropomorphic dummy of a “95th percentile” male, such as is commonly used in automotive safety and ergonomics testing. Details of the 95^{th} percentile model for such embodiment are as defined in PART 571 of the Federal Motor Vehicle Safety Standards on CRASHWORTHINESS, Standard No. 208—Occupant Crash Protection (also 49 CFR 571.208, Code of Federal Regulations Title 49, Volume 5, Revised as of Oct. 1, 2003, Pages 492-571), which is hereby incorporated in its entirety by reference. The model 36 is positioned in the seat 32 (occupants of which are to be protected by the airbag). The seat 32 is centered in its fore/aft adjustment range. If the seat 32 has an adjustable elevation, it may also be centered in its vertical adjustment range. A seatback 38 of the seat is tilted to an angle that is as close as possible to an expected typical seatback angle, an angle frequently referred to in the art as the “design angle” of the seat back.

A base vertical reference (VR) level 40 is used to locate the FOV point. In one embodiment, the VR level 40 is a horizontal plane (having constant vertical dimension) that passes through a hip pivot point 42. The hip pivot point 42 may typically be referred to in the art as the “H” point of the model. In another embodiment, the VR level is a horizontal plane that is tangent to the seat being protected. The FOV point 30 for the particular seat is located in a horizontal plane that is located a certain distance, as indicated by an arrow 44, above the VR level 40. In one embodiment, the FOV point 30 is in a horizontal FOV plane located 442 mm above the VR level 40. In other embodiments the vertical plane of the FOV point 30 may be 442 mm +/−20 mm above the VR level 40. In further embodiments, the distance between the FOV and VR planes (as indicated by an arrow 44) may be approximately 400 mm, approximately 420 mm, approximately 470 mm, or approximately 500 mm. The most desirable value may depend, for example, upon the range of sizes of occupants for which image information is intended to be used to condition airbag deployment. The desirable value will also depend upon how the VR level 40 is defined.

In addition to being located in a particular horizontal plane as described above, the FOV point 30 is centered on the model, i.e., it is located at a lateral (or X dimension) position matching that of a center of the model 36. The FOV point is located a selected distance forward of the “chest” of the model 36, as indicated by an arrow 46. In one embodiment, the model 36 represents a 95^{th} percentile male occupant, as described above, and the model 36 is positioned as described above, and the FOV point is 75 mm forward of the chest of the model 36. In other embodiments, the FOV point may be 75 +/−20 mm in front of the model 36, or it may be 25 mm, 50 mm, or 100 mm forward of the chest of the model 36.

FIG. 4 illustrates some limitations which may be usefully imposed upon the position of the camera 34 in the X and Y dimensions. In particular, the camera 34 (as defined by its received image point) may be located within a shaded region 54. The shaded region 54 is disposed between a curve 56, reflecting a maximum radius from the FOV point, and a curve 58, representing a minimum radius from the FOV point, and may be limited, as shown, to a region that is proximate the vehicle headliner, as described above with respect to FIGS. 1 and 2.

FIG. 4 also illustrates a lateral (Y dimension) limitation that may be imposed upon the location of the camera 34. The camera 34 may be constrained laterally so as not to be “in line” with the driver side (inside) edge of the passenger seat 32. Stated more explicitly, the camera 34 may be precluded from being disposed in any vertical fore/aft plane (X-Z plane) that passes through the passenger seat 32. To define this constraint, an edge plane 60 is defined wherein the plane 60 represents an edge of the seat 32. The camera 34 may be required to be positioned opposite from an occupant 62 with respect to the edge plane 60. The edge plane 60 of the occupant's seat 32 may be defined as an X-Z plane passing through the edge of the occupant's seat 32 on a side closest to the camera position. However, in some situations, such as in vehicles having bench seats, the edge of the physical seat 32 may not reflect expected positions of the occupant 62. Therefore, the seat edge plane 60 may be defined differently in accordance with particular vehicle geometries. For example, the seat edge plane 60 may be defined by the expected lateral range of the occupant 62. In particular, the seat edge plane 60 may pass through the expected X-dimension range limit of the typical sitting position of an occupant (on the side closest to the camera 34), or, alternatively, through the X-dimension range limit typically expected for the shoulder position of the occupant (on the side toward the camera 34).

FIG. 5 illustrates useful location range limits for the camera 34 in the X and Z dimensions. The camera 34 may be constrained to be positioned within a region 64 between a maximum radius 66 and a minimum radius 68 from the FOV point 30. Of course, this constraint may be in addition to fore/aft or Y dimension constraints with respect to a windshield header 70, and to vertical or Z dimension constraints with respect to the vehicle header 70, as described above with respect to FIGS. 1 and 2.

FIG. 6 illustrates useful location range limits for the camera 34 in a Y-Z plane. The camera 34 location, as defined by the image-entrance point, may be constrained to be within a region 74 that is located between a maximum radius 76 and a minimum radius 78 from the FOV point 30. The camera 34 may, of course, simultaneously be constrained to be on an opposite side of the occupant 62 from the seat edge plane 60. To help ensure that the entire head of the occupant is within the field of view of the camera 34 throughout the typical range of motion of the occupant 62, the camera 34 may be further constrained to be positioned within line of sight (i.e., have an unobstructed view) of all, or a significant portion, of the top of the occupant's window (as indicated in FIG. 6 by a dotted arrow 80). Of course, this requirement may not only limit the X and Z dimensions shown in FIG. 6, but it may also limit an X dimension of the position of the camera 34.

Conclusion

The foregoing description illustrates exemplary implementations, and novel features, of aspects of an airbag system that utilizes an imaging sensor to obtain current information about an occupant for purposes of conditioning deployment of the airbag. The description focuses upon desirable positioning of the imaging sensor. In general, other aspects of the airbag system may be selected as desired for particular vehicles and airbag systems. However, some embodiments are explicitly limited to airbag systems that glean, from a single, solitary imaging sensor, all current information about an occupant that is needed to condition airbag deployment for the occupant.

The skilled person will understand that various omissions, substitutions, and changes in the form and details of the methods and apparatus illustrated may be made without departing from the scope of the invention. It is impractical to list all embodiments explicitly. As such, each practical combination of camera position constraints set forth above, or shown in the attached figures, or described in the following claims, together with each practical combination of equivalents of such constraints, constitutes a distinct alternative embodiment of the subject airbag system or apparatus. Due to the impracticality of exhaustively setting forth each possible embodiment of the invention, the scope of the presented invention should be determined only by reference to the appended claims, and is not to be construed as limited by any particular features described in the foregoing description except insofar as such limitation is recited in an appended claim.

All variations coming within the meaning and range of equivalency of the various claim elements are embraced within the scope of the corresponding claim. Each claim set forth below is intended to encompass any system or method that differs only insubstantially from the literal language of such claim, as long as such system or method is not, in fact, an embodiment of the prior art. To this end, each described element in each claim should be construed as broadly as possible, and moreover should be understood to encompass any equivalent to such element insofar as possible without also encompassing the prior art.

1. A method of controlling deployment of an airbag in a vehicle, the method comprising:
a) classifying an occupant of the vehicle as one of a plurality of possible classifications with regard to airbag deployment vulnerability, based upon information received by a processing facility obtained from a solitary imaging sensor for the airbag;
b) defining a suppression zone for the airbag having a longitudinal extent between suppression zone maximum and minimum longitudinal references of the vehicle;
c) determining whether an occupant is intruding upon the suppression zone based upon information about the occupant received exclusively from the solitary imaging sensor;
d) conditioning deployment of the airbag at least in part on the determination in step (c) as to whether the occupant is intruding upon the suppression zone for the airbag;
e) mounting the solitary imaging sensor such that an image entrance plane center (IEPC) point is disposed:
i) within 200 mm of an airbag suppression zone rear plane that defines a minimum longitudinal (rearmost) extent of the suppression zone, or within 200 mm of a windshield header of the vehicle if the windshield header is rearward of the airbag suppression zone rear plane; and
ii) 500 mm to 700 mm distant from a focus of view (FOV) point that is defined for the vehicle with respect to an expected typical position of the occupant.

2. The airbag deployment control method of claim 1, wherein in step (e)(iii) the IEPC point of the solitary imaging sensor is disposed 530 mm to 675 mm from the FOV point.

3. The airbag deployment method of claim 2, wherein the FOV point is defined in the range 400 mm to 484 mm vertically above a hip pivot axis and 50 mm to 100 mm horizontally in front of a chest of a model occupant disposed at an approximate center of a normal range of seat position.

4. The airbag deployment control method of claim 3, wherein the FOV point is approximately 442 mm vertically above the hip pivot axis.

5. The airbag deployment control method of claim 4, wherein the FOV point is approximately 75 mm longitudinally forward of the chest of a model occupant disposed at an approximate center of a normal range of seat position.

6. The airbag deployment control method of claim 5, wherein the FOV point is within line of sight of substantially all maximum vertical points of an opening for a window associated with the occupant.

7. The airbag deployment method of claim 1, wherein the FOV point is defined in the range 400 mm to 484 mm vertically above a hip pivot axis and 50 mm to 100 mm horizontally in front of a chest of a model occupant disposed at an approximate center of a normal range of seat position.

8. The airbag deployment control method of claim 4, wherein the FOV point is within line of sight of substantially all maximum vertical points of an opening for a window associated with the occupant.

9. A vehicle occupant imaging system obtaining information used to control deployment of a vehicle airbag device for an occupant, the system comprising:
a) an imaging camera having an image entrance plane with location defined in part by an image entrance plane center (IEPC) point;
b) an image processor configured to determine occupant classification and location information based upon image data obtained from the imaging camera; and
c) an airbag controller configured to determine when to deploy an airbag for the occupant, and configured to condition force and/or velocity of airbag deployment based upon the determination in step (b) of a location of the occupant with respect to an airbag suppression zone (ASZ);
d) wherein the IEPC point of the imaging camera is disposed:
i) within 200 mm of a plane that defines a minimum longitudinal (rearmost) extent of the ASZ, or within 200 mm of a windshield header of the vehicle if the windshield header is rearward of the ASZ rearmost plane; and
ii) 530 mm to 675 mm distant from a focus of view (FOV) point that is defined for the vehicle as a point that is 75 mm forward of a chest of a nominal occupant positioned on a seat of the vehicle that is centered within an available fore-aft adjustment range, in a horizontal plane that is 442 mm vertically above a horizontal plane that passes through a hip pivot point of the nominal occupant, and is in a vertical plane that passes through a lateral center of the nominal occupant and is parallel to a longitudinal axis of the vehicle.

10. The system of claim 9, wherein all position information with respect to a current occupant used by the system to condition airbag deployment is based upon imaging data obtained from the imaging camera.

11. The system of claim 10, wherein the IEPC point of the imaging camera is further disposed such that a predetermined portion of an upper extreme of a window is within a field of view of the imaging camera

12. The system of claim 11, wherein the FOV point is determined with respect to the nominal occupant when a back of the seat on which such nominal occupant is positioned is tilted at an angle expected to be typical for actual occupants.

13. The system of claim 12, wherein the nominal occupant is configured to represent a male of a size that is approximately a 95^{th} percentile for the expected population of actual male occupants.

14. The system of claim 13, wherein a window corresponds to the occupant, and wherein (d)(iii) the IEPC point of the imaging camera is further disposed farther away from the corresponding window than any vertical plane parallel to the longitudinal axis of the vehicle that passes through a torso of the nominal occupant.

15. The system of claim 14, wherein the FOV point is within line of sight of substantially all maximum vertical points of an opening for the window corresponding to the occupant.

16. The system of claim 10, wherein (d) the IEPC point of the imaging camera is further disposed (iii) such that raw images from the camera include at least two points whose spatial relationship to the vehicle can be determined by the image processor.
